(19) United States
(12) Patent Application Publication
(10) Pub. No.: US 2011/0009547 A1
(43) Pub. Date: Jan. 13, 2011

(54) RUBBER COMPOSITION FOR A TYRE COMPRISING A HYDROXYSILANE COVERING AGENT

(76) Inventors: Jose Carlos Araujo Da Silva, Pont Du Chateau (FR); Laure Belin, Riom (FR); Karine Longchambon, Beaumont (FR); Nicolas Seeboth, Clermont-Ferrand (FR)

Correspondence Address: BUCHANAN, INGERSOLL & ROONEY PC, POST OFFICE BOX 1404, ALEXANDRIA, VA, 22313-1404, US

(21) Appl. No.: 12/742,030

(22) PCT Filed: Nov. 14, 2008
(86) PCT No.: PCT/EP2008/009652

§ 371 Date: Aug. 13, 2010

(30) Foreign Application Priority Data
Nov. 15, 2007 (FR) 0759050

(51) Int. Cl. C08K 5/5415

(52) U.S. Cl. 524/265

(57) ABSTRACT

Rubber composition which can be used in particular for the manufacture of tyres or tyre semi-finished products, such as treads, the said composition being based on at least a diene elastomer, a reinforcing inorganic filler, a coupling agent and a hydroxysilane of formula (I):

R¹(R²)ₙSi(OH)₃₋ₙ

in which:
n is equal to 0, 1 or 2;
R¹ represents a hydrocarbon group having at least 4 carbon atoms;
R² represents an alkyl having from 1 to 4 carbon atoms, the R² alkyls being identical or different if n is equal to 2.

The present invention relates to diene elastomer compositions reinforced with an inorganic filler, such as silica, which can be used in particular in the manufacture of tyres or semi-finished products for tyres, such as treads.

It also relates to the processing aids capable of improving the processing property and reducing the viscosity in the raw state of such rubber compositions, more particularly to covering agents capable of bonding via covalent bonds to the surface functional sites of the inorganic filler.

During the last fifteen years, tyres simultaneously exhibiting a low rolling resistance, an improved grip, both on a dry surface and on a wet or snowy surface, and an excellent wear resistance have been able to be obtained by virtue of the development of novel elastomer compositions reinforced with specific inorganic fillers, described as “reinforcing”, which exhibit a high dispersibility, which are capable of competing, from the reinforcing viewpoint, with tyre-grade carbon blacks and which additionally afford these compositions a reduced hysteresis synonymous with a lower rolling resistance for the tyres comprising them.

The processability of the rubber compositions comprising such inorganic fillers, in particular silicas, nevertheless remains more difficult than for the rubber compositions conventionally comprising carbon black as filler. This difficulty is due in a known way to a high surface reactivity of the particles of inorganic fillers and thus a strong natural propensity of these particles to agglomerate with one another, thus reducing the dispersibility of the filler in the rubber matrix.

In a known way, it is in particular necessary to use a coupling agent, also referred to as bonding agent, the role of which is, on the one hand, to provide the connection between the surface of the particles of inorganic filler and the elastomer and, on the other hand, to facilitate the dispersion of this inorganic filler within the elastomeric matrix by virtue of partial covering of the surface of the particles.

It should be remembered here that (inorganic filler/elastomer) “coupling” agent has to be understood, in a known way, as meaning an agent capable of establishing a satisfactory connection, of chemical and/or physical nature, between inorganic filler and the diene elastomer.

Such a coupling agent, which is at least bifunctional, has as simplified general formula “Y-W-X”, in which:
Y represents a functional group (“Y” functional group) which is capable of being physically and/or chemically bonded to the inorganic filler, it being possible for such a bond to be established, for example, between a silicon atom of the coupling agent and the surface hydroxyl (OH) groups of the inorganic filler (for example, the surface silanols, when silica is concerned);
X represents a functional group (“X” functional group) capable of being physically and/or chemically bonded to the diene elastomer, for example via a sulphur atom;
W represents a divalent group which makes it possible to connect “Y” and “X”.

The silica/diene elastomer coupling agents are well known to a person skilled in the art, the most well known being silane bifunctional sulphides, in particular alkoxysilane sulphides, regarded today as the products contributing, for vulcanizates comprising silica as filler, the best compromise in terms of scorch safety, of ease of processability and of reinforcing power. Mention may in particular be made, among these silane sulphides, of bis(3-triethoxysilylpropyl) tetrasulphide (abbreviated to TESPT), the reference coupling agent in tyres with a low rolling resistance described as “Green Tyres” for the energy saving afforded by their rubber compositions (“Energy-saving Green Tyres” concept).

“Covering” agents for the inorganic filler particles can also be used, which agents are capable of further improving, by being bonded to the surface functional sites of the inorganic filler and by thus at least partially covering it, the dispersion of the latter in the elastomeric matrix, thus lowering its viscosity in the raw state and improving overall its processability.

Such covering agents belong essentially to the family of the polyols (for example diols or triols, such as glycerol or its derivatives), polyethers (for example polyethylene glycols), primary, secondary or tertiary amines (for example trialkanolamines), hydroxylated or hydrolysable polyorganosiloxanes, for example α,ω-dihydroxypolyorganosiloxanes (in particular α,ω-dihydroxypolydimethylsiloxanes), hydroxysilanes or alkylalkoxysilanes, in particular alkyltriethoxysilanes, such as, for example, (1-octyl)triethoxysilane, sold by Degussa under the name “Dynasylan Octeo”. These covering agents are well known in tyre rubber compositions reinforced with an inorganic filler; they have been described, by way of examples, in Patent Applications WO 00/05300, WO 01/55252, WO 01/96442, WO 02/031041, WO 02/053634, WO 02/083782, WO 03/002648, WO 03/002653, WO 03/016387, WO 2006/002993, WO 2006/125533, WO 2007/017060 and WO 2007/003408.

These covering agents must not be confused with the coupling agents. They can, in a known way, comprise the “Y” functional group, active with regard to the inorganic filler, but are in all cases devoid of the “X” functional group, active with regard to the diene elastomer.

On continuing their research studies, the Applicant Companies have discovered a novel rubber composition which, by virtue of a specific hydroxysilane covering agent, exhibits properties which are further improved in comparison with the best rubber compositions known for Green Tyres.

Consequently, a first subject-matter of the invention is a rubber composition based on at least a diene elastomer, a reinforcing inorganic filler, a coupling agent and a hydroxysilane of formula (I):

R¹(R²)ₙSi(OH)₃₋ₙ

in which:
n is equal to 0, 1 or 2;
R¹ represents a hydrocarbon group having at least 4 carbon atoms;
R² represents an alkyl having from 1 to 4 carbon atoms, the R² alkyls being identical or different if n is equal to 2.

By virtue of the use of such a hydroxysilane of formula (I), the rubber composition of the invention exhibits not only an improved processability in the raw state but also a reduced hysteresis, which is synonymous with a lower rolling resistance and thus with a reduced energy consumption for motor vehicles equipped with tyres using a composition according to the invention.

Another subject-matter of the invention is a process for preparing a rubber composition according to the invention, the said process comprising the following stages:
incorporating in a diene elastomer, during a first “non-productive” stage, at least one reinforcing inorganic filler and one coupling agent, the combined mixture being kneaded thermomechanically until a maximum temperature of between 110° C. and 190° C. is reached;
cooling the combination to a temperature of less than 100° C.;
subsequently incorporating, during a second “productive” stage, a crosslinking (or vulcanizing) system;
kneading the combined mixture until a maximum temperature of less than 120° C. is reached,
   and being characterized in that a hydroxysilane of formula (I) above is additionally incorporated during the non-productive stage and/or the productive stage.

Another subject-matter of the invention is the use of a composition according to the invention for the manufacture of finished articles or semi-finished products comprising a rubber composition in accordance with the invention, these articles or products being intended in particular for any motor vehicle ground-contact system, such as tyres, internal safety supports for tyres, wheels, rubber springs, elastomeric joints, other suspension elements and vibration dampers.

A subject-matter of the invention is very particularly the use of a composition in accordance with the invention for the manufacture of tyres or of semi-finished products made of rubber intended for these tyres, these semi-finished products being chosen in particular from the group consisting of treads, crown reinforcing plies, sidewalls, carcass reinforcing plies, beads, protectors, underlayers, rubber blocks and other internal rubbers, in particular decoupling rubbers, intended to provide the bonding or the interface between the abovementioned regions of the tyres.

Another subject-matter of the invention is these finished articles, in particular these tyres, and these semi-finished products themselves when they comprise a rubber composition in accordance with the invention. The invention relates in particular to tyre treads, it being possible for these treads to be used during the manufacture of new tyres or for the retreading of worn tyres.

The composition in accordance with the invention is particularly suitable for the manufacture of tyres or of tyre treads intended for equipping passenger vehicles, 4×4 (4-wheel drive) vehicles, two-wheel vehicles, vans, heavy-duty vehicles, that is to say underground, bus, heavy road transport vehicles (lorries, tractors, trailers) or off-road vehicles, aircraft, earthmoving equipment, heavy agricultural vehicles or handling vehicles.

The invention and its advantages will be easily understood in the light of the description and of the exemplary embodiments which follow.

### I. MEASUREMENTS AND TESTS USED

The rubber compositions are characterized, before and after curing, as indicated below.

### A) Mooney Plasticity:

Use is made of an oscillating consistometer as described in French Standard NF T 43-005 (1991). The Mooney plasticity measurement is carried out according to the following principle: the composition in the raw state (i.e., before curing) is moulded in a cylindrical chamber heated to 100° C. After preheating for one minute, the rotor rotates within the test specimen at 2 revolutions/minute and the working torque for maintaining this movement is measured after rotating for 4 minutes. The Mooney plasticity (ML 1+4) is expressed in “Mooney unit” (MU, with 1 MU=0.83 newton.metre).

### B) Rheometry:

The measurements are carried out at 150° C. with an oscillating disc rheometer, according to standard DIN 53529—part 3 (June 1983). The change in the rheometric torque as a function of time describes the change in the stiffening of the composition as a result of the vulcanization reaction. The measurements are processed according to standard DIN 53529-part 2 (March 1983): Ti is the induction period, that is to say the time necessary for the start of the vulcanization reaction; T_{α} (for example T₉₉) is the time necessary to achieve a conversion of α%, that is to say α% (for example 99%) of the difference between the minimum and maximum torques. The conversion rate constant, denoted K (expressed as min⁻¹), which is first order, calculated between 30% and 80% conversion, which makes it possible to assess the vulcanization kinetics, is also measured.

### C) Shore A Hardness:

The Shore A hardness of the compositions after curing is assessed in accordance with Standard ASTM D 2240-86.

### D) Tensile Tests:

These tests make it possible to determine the elasticity stresses and the properties at break. Unless otherwise indicated, they are carried out in accordance with French Standard NF T 46-002 of September 1988. The nominal secant moduli (or apparent stresses, in MPa) are measured in elongation at 10% elongation (denoted M10), 100% elongation (M100) and 300% elongation (M300). The breaking stresses (in MPa) and the elongations at break (in %) are also measured.

### E) Dynamic Properties:

The dynamic properties ΔG* and tan(δ)ₘₐₓ are measured on a viscosity analyser (Metravib VA4000) according to Standard ASTM D 5992-96. The response of a sample of vulcanized composition (cylindrical test specimen with a thickness of 4 mm and with a cross section of 400 mm²), subjected to a simple alternating sinusoidal shear stress, at a frequency of 10 Hz, is recorded at 23° C. or 40° C. A strain amplitude sweep is carried out from 0.1% to 50% (outward cycle) and then from 50% to 1% (return cycle). The results made use of are the complex dynamic shear modulus (G*) and the loss factor (tan δ). The maximum value of tan δ observed (tan(δ)ₘₐₓ) and the difference in complex modulus (ΔG*) between the values at 0.1% and at 50% strain (Payne effect) are shown for the return cycle.

### II. DETAILED DESCRIPTION OF THE INVENTION

The rubber compositions according to the invention are based on at least: (i) a (that is to say at least one) diene elastomer; (ii) a (at least one) inorganic filler as reinforcing filler; (iii) a (at least one) agent for coupling the said filler to the said elastomer and (iv) a (at least one) specific hydroxysilane of formula (I) performing the role of covering agent with regard to the reinforcing inorganic filler.

Of course, the expression “composition based on” should be understood as meaning a composition comprising the mixture and/or the reaction product of the various constituents used, some of these base constituents (for example the reinforcing inorganic filler, the coupling agent and the covering agent) being capable of reacting or intended to react with one another, at least in part, during the various phases of manufacture of the compositions, in particular during their vulcanization (curing).

In the present description, unless expressly indicated otherwise, all the percentages (%) shown are % by weight. Moreover, any interval of values denoted by the expression “between a and b” represents the range of values extending from greater than a to less than b (i.e., limits a and b excluded), whereas any interval of values denoted by the expression “from a to b” means the range of values extending from a up to b (i.e., including the strict limits a and b).

### II-1. Diene Elastomer

The term “diene” elastomer or rubber should be understood as meaning, in a known way, an (one or more are understood) elastomer resulting at least in part (i.e., a homopolymer or a copolymer) from diene monomers (monomers carrying two carbon-carbon double bonds which may or may not be conjugated).

These diene elastomers can be classified into two categories: “essentially unsaturated” or “essentially saturated”. The term “essentially unsaturated” is understood to mean generally a diene elastomer resulting at least in part from conjugated diene monomers having a level of units of diene origin (conjugated dienes) which is greater than 15% (mol %); thus it is that diene elastomers such as butyl rubbers or copolymers of dienes and of α-olefins of EPDM type do not come within the preceding definition and can in particular be described as “essentially saturated” diene elastomers (low or very low level of units of diene origin, always less than 15%). In the category of “essentially unsaturated” diene elastomers, the term “highly unsaturated” diene elastomer is understood to mean in particular a diene elastomer having a level of units of diene origin (conjugated dienes) which is greater than 50%.

Given these definitions, the term diene elastomer capable of being used in the compositions in accordance with the invention is understood more particularly to mean:
(a) —any homopolymer obtained by polymerization of a conjugated diene monomer having from 4 to 12 carbon atoms;
(b) —any copolymer obtained by copolymerization of one or more conjugated dienes with one another or with one or more vinylaromatic compounds having from 8 to 20 carbon atoms;
(c) —a ternary copolymer obtained by copolymerization of ethylene and of an α-olefin having 3 to 6 carbon atoms with a non-conjugated diene monomer having from 6 to 12 carbon atoms, such as, for example, the elastomers obtained from ethylene and propylene with a non-conjugated diene monomer of the abovementioned type, such as, in particular, 1,4-hexadiene, ethylidenenorbornene or dicyclopentadiene;
(d) —a copolymer of isobutene and of isoprene (butyl rubber) and also the halogenated versions, in particular chlorinated or brominated versions, of this type of copolymer.

Although it applies to any type of diene elastomer, a person skilled in the art of tyres will understand that the present invention is preferably employed with essentially unsaturated diene elastomers, in particular of the type (a) or (b) above.

The following are suitable in particular as conjugated dienes: 1,3-butadiene, 2-methyl-1,3-butadiene, 2,3-di(C₁-C₅ alkyl)-1,3-butadienes, such as, for example, 2,3-dimethyl-1,3-butadiene, 2,3-diethyl-1,3-butadiene, 2-methyl-3-ethyl-1,3-butadiene or 2-methyl-3-isopropyl-1,3-butadiene, an aryl-1,3-butadiene, 1,3-pentadiene or 2,4-hexadiene. The following, for example, are suitable as vinylaromatic compounds: styrene, ortho-, meta- or para-methylstyrene, the “vinyltoluene” commercial mixture, para-(tert-butyl)styrene, methoxystyrenes, chlorostyrenes, vinylmesitylene, divinylbenzene or vinylnaphthalene.

The copolymers can comprise between 99% and 20% by weight of diene units and between 1% and 80% by weight of vinylaromatic units. The elastomers can have any microstructure which depends on the polymerization conditions used, in particular on the presence or absence of a modifying and/or randomizing agent and on the amounts of modifying and/or randomizing agent employed. The elastomers can, for example, be block, random, sequential or microsequential elastomers and can be prepared in dispersion or in solution; they can be coupled and/or star-branched or also functionalized with a coupling and/or star-branching or functionalization agent. For coupling with carbon black, mention may be made, for example, of functional groups comprising a C—Sn bond or of aminated functional groups, such as benzophenone, for example; for coupling with a reinforcing inorganic filler, such as silica, mention may be made, for example, of silanol functional groups or polysiloxane groups having a silanol end (such as described, for example, in FR 2 740 778 or U.S. Pat. No. 6,013,718), of alkoxysilane groups (such as described, for example, in FR 2 765 882 or U.S. Pat. No. 5,977,238), of carboxyl groups (such as described, for example, in WO 01/92402 or U.S. Pat. No. 6,815,473, WO 2004/096865 or US 2006/0089445) or of polyether groups (such as described, for example, in EP 1 127 909 or U.S. Pat. No. 6,503,973). Mention may also be made, as other examples of functionalized elastomers, of the elastomers (such as SBR, BR, NR or IR) of the epoxidized type.

The following are suitable: polybutadienes, in particular those having a content (molar %) of 1,2-units of between 4% and 80% or those having a content (molar %) of cis-1,4-units of greater than 80%, polyisoprenes, butadiene/styrene copolymers and in particular those having a glass transition temperature (Tg, measured according to ASTM D3418) of between 0° C. and −70° C. and more particularly between −10° C. and −60° C., a styrene content of between 5% and 60% by weight and more particularly between 20% and 50%, a content (molar %) of 1,2-bonds of the butadiene part of between 4% and 75% and a content (molar %) of trans-1,4-bonds of between 10% and 80%, butadiene/isoprene copolymers, in particular those having an isoprene content of between 5% and 90% by weight and a Tg of −40° C. to −80° C., or isoprene/styrene copolymers, in particular those having a styrene content of between 5% and 50% by weight and a Tg of between −25° C. and −50° C. In the case of butadiene/styrene/isoprene copolymers, those having a styrene content of between 5% and 50% by weight and more particularly of between 10% and 40%, an isoprene content of between 15% and 60% by weight and more particularly between 20% and 50%, a butadiene content of between 5% and 50% by weight and more particularly of between 20% and 40%, a content (molar %) of 1,2-units of the butadiene part of between 4% and 85%, a content (molar %) of trans-1,4-units of the butadiene part of between 6% and 80%, a content (molar %) of 1,2- plus 3,4-units of the isoprene part of between 5% and 70% and a content (molar %) of trans-1,4-units of the isoprene part of between 10% and 50%, and more generally any butadiene/styrene/isoprene copolymer having a Tg of between −20° C. and −70° C., are suitable in particular.

To sum up, the diene elastomer of the composition in accordance with the invention is preferably chosen from the group of the highly unsaturated diene elastomers consisting of polybutadienes (abbreviated to “BR”), synthetic polyisoprenes (IR), natural rubber (NR), butadiene copolymers, isoprene copolymers and the mixtures of these elastomers. Such copolymers are more preferably chosen from the group consisting of butadiene/styrene copolymers (SBR), isoprene/butadiene copolymers (BIR), isoprene/styrene copolymers (SIR) and isoprene/butadiene/styrene copolymers (SBIR).

According to a specific embodiment, the diene elastomer is predominantly (i.e., for more than 50 pce) an SBR, whether an SBR prepared in emulsion (“ESBR”) or an SBR prepared in solution (“SSBR”), or an SBR/BR, SBR/NR (or SBR/IR), BR/NR (or BR/IR) or also SBR/BR/NR (or SBR/BR/TR) blend (mixture). In the case of an SBR (ESBR or SSBR) elastomer, use is made in particular of an SBR having a moderate styrene content, for example of between 20% and 35% by weight, or a high styrene content, for example from 35 to 45%, a content of vinyl bonds of the butadiene part of between 15% and 70%, a content (molar %) of trans-1,4-bonds of between 15% and 75% and a Tg of between −10° C. and −55° C.; such an SBR can advantageously be used as a mixture with a BR preferably having more than 90% (molar %) of cis-1,4-bonds.

According to another specific embodiment, the diene elastomer is predominantly (for more than 50 pce) an isoprene elastomer. This is the case in particular when the compositions of the invention are intended to constitute, in the tyres, rubber matrices of certain treads (for example for industrial vehicles), of crown reinforcing plies (for example of working plies, protection plies or hooping plies), of carcass reinforcing plies, of sidewalls, of beads, of protectors, of underlayers, of rubber blocks and other internal rubbers providing the interface between the abovementioned regions of the tyres.

The term “isoprene elastomer” is understood to mean, in a known way, an isoprene homopolymer or copolymer, in other words a diene elastomer chosen from the group consisting of natural rubber (NR), synthetic polyisoprenes (IR), the various copolymers of isoprene and the mixtures of these elastomers. Mention will in particular be made, among isoprene copolymers, of isobutene/isoprene copolymers (butyl rubber-IIR), isoprene/styrene copolymers (SIR), isoprene/butadiene copolymers (BIR) or isoprene/butadiene/styrene copolymers (SBIR). This isoprene elastomer is preferably natural rubber or a synthetic cis-1,4-polyisoprene; use is preferably made, among these synthetic polyisoprenes, of the polyisoprenes having a level (molar %) of cis-1,4-bonds of greater than 90%, more preferably still of greater than 98%.

According to another specific embodiment, in particular when it is intended for a tyre sidewall or for an airtight internal rubber of a tubeless tyre (or other air-impermeable component), the composition in accordance with the invention can comprise at least one essentially saturated diene elastomer, in particular at least one EPDM copolymer or one butyl rubber (optionally chlorinated or brominated), whether these copolymers are used alone or as a blend with highly unsaturated diene elastomers as mentioned above, in particular NR or IR, BR or SBR.

According to another preferred embodiment of the invention, the rubber composition comprises a blend of a (one or more) “high Tg” diene elastomer exhibiting a Tg of between −70° C. and 0° C. and of a (one or more) “low Tg” diene elastomer of between −110° C. and −80° C., more preferably between −105° C. and −90° C. The high Tg elastomer is preferably chosen from the group consisting of S-SBRs, E-SBRs, natural rubber, synthetic polyisoprenes (exhibiting a level (molar %) of cis-1,4-structures preferably of greater than 95%), BIRs, SIRs, SBIRs and the mixtures of these elastomers. The low Tg elastomer preferably comprises butadiene units according to a level (molar %) at least equal to 70%; it preferably consists of a polybutadiene (BR) exhibiting a level (molar %) of cis-1,4-structures of greater than 90%.

According to another specific embodiment of the invention, the rubber composition comprises, for example, from 30 to 100 pce, in particular from 50 to 100 pce, of a high Tg elastomer as a blend with 0 to 70 pce, in particular from 0 to 50 pce, of a low Tg elastomer; according to another example, it comprises, for the whole of the 100 pce, one or more SBR(s) prepared in solution.

According to another specific embodiment of the invention, the diene elastomer of the composition according to the invention comprises a blend of a BR (as low Tg elastomer) exhibiting a level (molar %) of cis-1,4-structures of greater than 90% with one or more S-SBRs or E-SBRs (as high Tg elastomer(s)).

The compositions of the invention can comprise a single diene elastomer or a mixture of several diene elastomers, it being possible for the diene elastomer or elastomers to be used in combination with any type of synthetic elastomer other than a diene elastomer, indeed even with polymers other than elastomers, for example thermoplastic polymers.

### II-2. Reinforcing Inorganic Filler

The term “reinforcing inorganic filler” should be understood as meaning here, in a known way, any inorganic or mineral filler, whatever its colour and its origin (natural or synthetic), also known as “white” filler, “clear” filler or even “non-black” filler, in contrast with carbon black, this inorganic filler being capable of reinforcing, by itself alone, without means other than an intermediate coupling agent, a rubber composition intended for the manufacture of a tyre tread, in other words capable of replacing, in its reinforcing role, a conventional tyre-grade carbon black for a tread. Such a filler is generally characterized by the presence of functional groups, in particular hydroxyl (—OH) groups, at its surface, thus requiring the use of a coupling agent or system intended to provide a stable chemical bond between the isoprene elastomer and the said filler.

Preferably, the reinforcing inorganic filler is a filler of the siliceous or aluminous type or a mixture of these two types of fillers.

The silica (SiO₂) used can be any reinforcing silica known to a person skilled in the art, in particular any precipitated or pyrogenic silica exhibiting a BET specific surface and a CTAB specific surface which are both less than 450 m²/g, preferably from 30 to 400 m²/g. Highly dispersible precipitated silicas (“HDSs”) are preferred, in particular when the invention is employed for the manufacture of tyres exhibiting a low rolling resistance; mention may be made, as examples of such silicas, of the Ultrasil 7000 silicas from Degussa, the Zeosil 1165 MP, 1135 MP and 1115 MP silicas from Rhodia, the Hi-Sil EZ150G silica from PPG, the Zeopol 8715, 8745 or 8755 silicas from Huber or the silicas as described in the abovementioned Application WO 03/016387.

The reinforcing alumina (Al₂O₃) preferably used is a highly dispersible alumina having a BET specific surface ranging from 30 to 400 m²/g, more preferably between 60 and 250 m²/g, and a mean particle size at most equal to 500 nm, more preferably at most equal to 200 nm. Mention may in particular be made, as nonlimiting examples of such reinforcing aluminas, of the “Baikalox A125” or “CR125” (Baïkowski), “APA-100RDX” (Condea), “Aluminoxid C” (Degussa) or “AKP-G015” (Sumitomo Chemicals) aluminas.

Mention may also be made, as other examples of inorganic filler capable of being used in the rubber compositions of the invention, of aluminium (oxide) hydroxides, aluminosilicates, titanium oxides, silicon carbides or nitrides, all of the reinforcing type as described, for example, in Applications WO 99/28376, WO 00/73372, WO 02/053634, WO 2004/003067 and WO 2004/056915.

When the treads of the invention are intended for tyres with a low rolling resistance, the reinforcing inorganic filler used, in particular if it is silica, preferably has a BET specific surface of between 60 and 350 m²/g. An advantageous embodiment of the invention consists in using a reinforcing inorganic filler, in particular a silica, having a high BET specific surface within a range from 130 to 300 m²/g, due to the high reinforcing power recognized for such fillers. According to another preferred embodiment of the invention, use may be made of a reinforcing inorganic filler, in particular a silica, exhibiting a BET specific surface of less than 130 m²/g, preferably in such a case of between 60 and 130 m²/g (see, for example, Applications WO 03/002648 and WO 03/002649).

The physical state under which the reinforcing inorganic filler is provided is not important, whether it is in the form of a powder, of microbeads, of granules, of balls or any other appropriate densified form. Of course, the term reinforcing inorganic filler is also understood to mean mixtures of different reinforcing inorganic fillers, in particular of highly dispersible siliceous and/or aluminous fillers as described above.

A person skilled in the art will know how to adjust the level of reinforcing inorganic filler according to the nature of the inorganic filler used and according to the type of tyre concerned, for example a tyre for a motorcycle, for a passenger vehicle or for a utility vehicle, such as a van or a heavy-duty vehicle. Preferably, this level of reinforcing inorganic filler will be chosen between 20 and 200 pce, more preferably between 30 and 150 pce, in particular greater than 40 pce (for example between 40 and 120 pce, in particular between 40 and 100 pce).

In the present account, the BET specific surface is determined in a known way by gas adsorption using the Brunauer-Emmett-Teller method described in “The Journal of the American Chemical Society”, Vol. 60, page 309, February 1938, more specifically according to French Standard NF ISO 9277 of December 1996 (multipoint volumetric method (5 points)—gas: nitrogen—degassing: 1 hour at 160° C.—relative pressure range p/po: 0.05 to 0.17). The CTAB specific surface is the external surface determined according to French Standard NF T 45-007 of November 1987 (method B).

Finally, a person skilled in the art will understand that a reinforcing filler of another nature, in particular an organic filler, might be used as equivalent filler to the reinforcing inorganic filler described in the present section, provided that this reinforcing filler is covered with an inorganic layer, such as silica, or else comprises, at its surface, functional sites, in particular hydroxyl sites, requiring the use of a coupling agent in order to establish the bonding between the filler and the elastomer. Mention may be made, as examples of such organic fillers, of functionalized polyvinylaromatic organic fillers, such as described in Applications WO 2006/069792 and WO 2006/069793.

### II-3. Coupling Agent

In order “to couple” the reinforcing inorganic filler to the diene elastomer, that is to say, to provide the connection between the said filler and the elastomer, use is made, in a known way, of an at least bifunctional coupling agent (or bonding agent) intended to provide a satisfactory connection, of chemical and/or physical nature, between the inorganic filler (surface of its particles) and the diene elastomer, in particular at least bifunctional organosilanes or polyorganosiloxanes.

Use is made in particular of silane polysulphides, referred to as “symmetrical” or “unsymmetrical” depending on their specific structure, as described, for example, in Applications WO 03/002648 (or US 2005/016651) and WO 03/002649 (or US 2005/016650).

Silane polysulphides corresponding to the following general formula (II):

Z-A-Sₓ-A-Z (II), in which:
x is an integer from 2 to 8 (preferably from 2 to 5);
the symbols A, which are identical or different, represent a divalent hydrocarbon radical (preferably a C₁-C₁₈ alkylene group or a C₆-C₁₂ arylene group, more particularly a C₁-C₁₀, in particular C₁-C₄, alkylene, especially propylene);
the symbols Z, which are identical or different, correspond to one of the three formulae below:

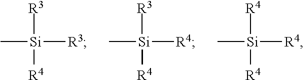

in which:
the R³ radicals, which are unsubstituted or substituted and identical to or different from one another, represent a C₁-C₁₈ alkyl, C₅-C₁₈ cycloalkyl or C₆-C₁₈ aryl group (preferably, C₁-C₆ alkyl, cyclohexyl or phenyl groups, in particular C₁-C₄ alkyl groups, more particularly methyl and/or ethyl),
the R⁴ radicals, which are unsubstituted or substituted and identical to or different from one another, represent a C₁-C₁₈ alkoxyl or C₅-C₁₈ cycloalkoxyl group (preferably a group chosen from C₁-C₈ alkoxyls and C₅-C₈ cycloalkoxyls, more preferably still a group chosen from C₁-C₄ alkoxyls, in particular methoxyl and ethoxyl),
   are suitable in particular, without the above definition being limiting.

In the case of a mixture of alkoxysilane polysulphides corresponding to the above formula (II), in particular the usual mixtures available commercially, the mean value of the “x” index is a fractional number preferably of between 2 and 5, more preferably in the vicinity of 4. However, the invention can also advantageously be carried out, for example, with alkoxysilane disulphides (x=2).

Mention will more particularly be made, as examples of silane polysulphides, of bis((C₁-C₄)alkoxyl (C₁-C₄)alkylsilyl(C₁-C₄)alkyl) polysulphides (in particular disulphides, trisulphides or tetrasulphides), such as, for example, bis(3-trimethoxysilylpropyl) or bis(3-triethoxysilylpropyl) polysulphides. Use is in particular made, among these compounds, of bis(3-triethoxysilylpropyl) tetrasulphide, abbreviated to TESPT, of formula [(C₂H₅O)₃Si(CH₂)₃S₂]₂, or bis(triethoxysilylpropyl) disulphide, abbreviated to TESPD, of formula [(C₂H₅O)₃Si(CH₂)₃S]₂. Mention will also be made, as preferred examples, of bis(mono(C₁-C₄)alkoxyldi(C₁-C₄)alkylsilylpropyl) polysulphides (in particular disulphides, trisulphides or tetrasulphides), more particularly bis(monoethoxydimethylsilylpropyl) tetrasulphide, such as described in the abovementioned Patent Application WO 02/083782 (or U.S. Pat. No. 7,217,751).

Mention will in particular be made, as example of coupling agents other than an alkoxysilane polysulphide, of bifunctional POSs (polyorganosiloxanes) or of hydroxysilane polysulphides (R⁴═OH in the above formula II), such as described, for example, in Patent Applications WO 02/30939 (or U.S. Pat. No. 6,774,255), WO 02/31041 (or US 2004/051210) and WO 2007/061550, or of silanes or POSs carrying azodicarbonyl functional groups, such as described, for example, in Patent Applications WO 2006/125532, WO 2006/125533 and WO 2006/125534.

Mention will be made, as examples of other silane sulphides, for example, of silanes carrying at least one thiol (—SH) functional group (referred to as mercaptosilanes) and/or at least one masked thiol functional group, such as described, for example, in Patents or Patent Applications U.S. Pat. No. 6,849,754, WO 99/09036, WO 2006/023815 and WO 2007/098080.

Of course, use might also be made of mixtures of the coupling agents described above, as described in particular in the abovementioned Application WO 2006/125534.

In the rubber compositions in accordance with the invention, the content of coupling agent is preferably between 2 and 15 pce, more preferably between 4 and 10 pce.

A person skilled in the art will understand that a reinforcing filler of another nature, in particular organic nature, might be used as filler equivalent to the reinforcing inorganic filler described in the present section, provided that this reinforcing filler is covered with an inorganic layer, such as silica, or else comprises, at its surface, functional sites, in particular hydroxyls, requiring the use of a coupling agent in order to form the connection between the filler and the elastomer.

### II-4. Covering Agent

The rubber composition of the invention has the essential characteristic of comprising a hydroxysilane of formula (I):

R¹(R²)ₙSi(OH)₃₋ₙ

in which:
n is an integer equal to 0, 1 or 2;
R¹ represents a hydrocarbon group having at least 4 carbon atoms;
R² represents an alkyl having from 1 to 4 carbon atoms, the R² alkyls being identical or different if n is equal to 2.

In other words, the above compound (I) is a hydroxysilane corresponding to one of the specific formulae which follow:

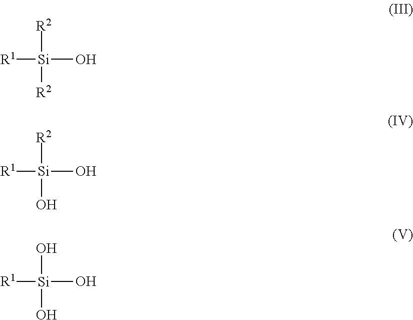

The above monohydroxysilanes (formula III), dihydroxysilanes (formula IV) and tri-hydroxysilanes (formula V) have, by virtue of the presence of their hydroxyl groups, the ability to act as covering agent for the inorganic filler by binding via covalent bonding to the surface functional sites of the inorganic filler, for example, in a known way, to the surface hydroxyl sites of the silica when the reinforcing inorganic filler is a silica. They thus improve the processability of the composition and reduce the viscosity in the raw state of the latter.

R¹ can optionally comprise one or more heteroatom(s) chosen from O, N and S.

According to a first preferred embodiment of the invention, R¹ is chosen from the group consisting of alkyls, cycloalkyls, aryls and aralkyls having at least 4 carbon atoms, in particular from 4 to 36 carbon atoms, it being possible for the said alkyls, cycloalkyls, aryls and aralkyls to comprise or not comprise one or more heteroatom(s) chosen from O, N and S.

R¹ is chosen in particular from the group consisting of alkyls having from 4 to 28 carbon atoms, cycloalkyls having from 6 to 28 carbon atoms, aryls having from 6 to 28 carbon atoms and aralkyls having from 7 to 28 carbon atoms.

According to another preferred form of the invention, R¹ is chosen from the group consisting of alkyls, cycloalkyls, aryls and aralkyls having more than 4 carbon atoms, in particular from 5 to 36 carbon atoms, it being possible for the said alkyls, cycloalkyls, aryls and aralkyls to comprise or not comprise one or more heteroatom(s) chosen from O, N and S. R¹ is more preferably chosen from the group consisting of alkyls having from 5 to 36, more particularly from 5 to 28 (for example from 5 to 20) carbon atoms, it being possible for the said alkyls to comprise one or more heteroatom(s) chosen from O, N and S.

R² preferably represents a methyl or ethyl group, more preferably a methyl group.

According to another more preferred form of the invention, n is equal to 1 or 2, that is to say that the covering agent is a monohydroxysilane of formula (III) or a dihydroxysilane of formula (IV), in particular in which R² is the methyl group and R¹ is an alkyl comprising from 4 to 36 (by way of example, from 4 to 28) carbon atoms, more preferably from 5 to 36 (by way of example, from 5 to 28) carbon atoms.

Mention will in particular be made, among such preferred monohydroxysilane or di-hydroxysilane compounds of general formula (III) or (IV), of the hydroxysilanes of formula (VI) or (VII) below for which R² is methyl and R¹ is —(CH₂)ₘCH₃, “m” being an integer greater than 2 (in particular included within a range from 3 to 35, in particular from 3 to 27), more preferably greater than 3 (in particular included within a range from 4 to 35, in particular from 4 to 27):

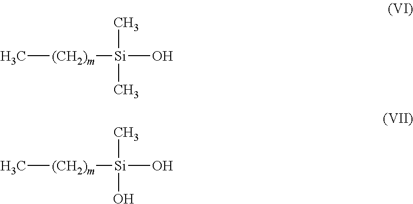

Use may also be made of trihydroxysilane compounds of general formula (IV) and specific formula (VIII) below, in particular those in which R¹ is —(CH₂)ₘCH₃ with m greater than 2 (in particular included within a range from 3 to 35, especially from 3 to 27), more preferably with m greater than 3 (in particular included within a range from 4 to 35, especially from 4 to 27):

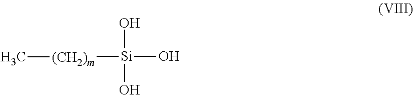

However, preference is given to the monohydroxysilanes and dihydroxysilanes of formulae (VI) and (VII) above.

Mention will in particular be made, as example of a preferred monohydroxysilane compound of formula (VI), of octyldimethylhydroxysilane of specific formula (VI-1) below corresponding to the general formula (III) in which R² is methyl and R¹ is octyl (—(CH₂)₇—CH₃):

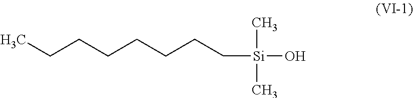

Mention will also very particularly be made of octadecyldimethylhydroxysilane of specific formula (VI-2), corresponding to the general formula (III) in which R² is methyl and R¹ is octadecyl (—(CH₂)₁₇—CH₃):

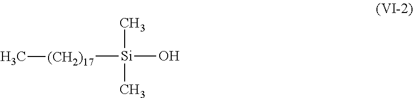

Mention will particularly be made, as example of a preferred dihydroxysilane compound of formula (VII), of octylmethyldihydroxysilane of formula (VII-1), corresponding to the general formula (IV) in which R² is methyl and R¹ is octyl (—(CH₂)₇—CH₃):

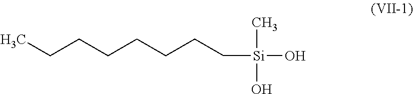

Mention will also very particularly be made of octadecylmethyldihydroxysilane of formula (VII-2), corresponding to the general formula (IV) in which R² is methyl and R¹ is octadecyl (—(CH₂)₁₇—CH₃):

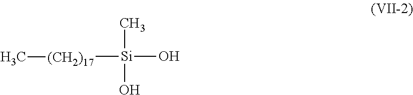

### II-5. Various Additives

The rubber compositions in accordance with the invention also comprise all or a portion of the usual additives generally used in elastomer compositions intended for the manufacture of tyres or tyre semi-finished products, such as, for example, plasticizing agents or extending oils, whether the latter are aromatic or nonaromatic in nature, covering agents other than the abovementioned ones of formula (I), pigments, protection agents, such as antiozone waxes, chemical antiozonants, antioxidants, antifatigue agents, reinforcing resins, plasticizing resins, bismaleimides, methylene acceptors (for example, phenolic novolak resin) or methylene donors (for example, HMT or H3M), a crosslinking system based either on sulphur or on sulphur donors and/or on peroxides and/or on bismaleimides, vulcanization accelerators and/or activators, or antireversion agents, such as, for example, sodium hexathiosulphonate or N,N′-m-phenylene biscitraconimide. A person skilled in the art will know how to adjust the formulation of the composition according to his specific requirements.

Preferably, these compositions of the invention comprise, as preferred nonaromatic or very slightly aromatic plasticizing agent, at least one compound chosen from the group consisting of naphthenic oils, paraffinic oils, MES oils, TDAE oils, ester plasticizers (for example glycerol trioleates), hydrocarbon resins exhibiting a high Tg preferably of greater than 30° C., such as described, for example, in Applications WO 2005/087859, WO 2006/061064 and WO 2007/017060, and the mixtures of such compounds. The overall level of such a preferred plasticizing agent is preferably between 10 and 100 pce, more preferably between 20 and 80 pce, in particular in a range from 10 to 50 pce.

Mention will in particular be made, among the above plasticizing hydrocarbon resins (it should be remembered that the name “resin” is reserved by definition for a solid compound), of resins formed of homo- or copolymers of α-pinene, β-pinene, dipentene or polylimonene, C₅ fraction, for example formed of C₅ fraction/styrene copolymer or formed of C₅ fraction/C₉ fraction copolymer, which can be used alone or in combination with plasticizing oils, such as, for example, IVIES oils or TDAE oils.

Inert fillers (i.e., non-reinforcing fillers), such as particles of clay, bentonite, talc, chalk, kaolin, which can be used, for example, in coloured tyre treads or sidewalls, can also be added, depending on the targeted application, to the reinforcing filler described above, that is to say the reinforcing inorganic filler plus carbon black, if appropriate.

II-6. Preparation of the rubber compositions

The compositions are manufactured in appropriate mixers using two successive preparation phases well known to a person skilled in the art: a first phase of thermomechanical working or kneading (sometimes described as “non-productive” phase) at high temperature, up to a maximum temperature (recorded as Tₘₐₓ) of between 110° C. and 190° C., preferably between 130° C. and 180° C., followed by a second phase of mechanical working (sometimes described as “productive” phase) at a lower temperature, typically of less than 120° C., for example between 60° C. and 100° C., finishing phase during which the crosslinking or vulcanization system is incorporated.

It is during the first “non-productive” phase that at least the reinforcing inorganic filler and the coupling agent are incorporated by kneading in the diene elastomer; these base constituents are introduced into the mixer and kneaded thermomechanically (in a single stage or in several stages) until a maximum temperature of between 110° C. and 190° C., preferably between 130° C. and 180° C., is reached.

By way of example, the first (non-productive) phase is carried out in a single thermomechanical stage during which diene elastomer(s), reinforcing inorganic filler and coupling agent are introduced into an appropriate mixer, such as a normal internal mixer, followed, in a second step, for example after kneading for one to two minutes, by the introduction of the various additives, with the exception of the vulcanization system. The total duration of the kneading, in this non-productive phase, is preferably between 2 and 10 min. After cooling the mixture thus obtained, the vulcanization system is then incorporated at low temperature, generally in an external mixer, such as an open mill; the combined mixture is then mixed (productive phase) for a few minutes, for example between 5 and 15 minutes.

All of the covering agent can be incorporated during the non-productive phase (i.e., in the internal mixer), at the same time as the inorganic filler, or else all of the covering agent can be incorporated during the productive phase (with the external mixer), or alternatively the covering agent can be incorporated divided up over the two successive phases. The invention also applies to the case where the reinforcing inorganic filler, in particular silica, is treated beforehand with the hydroxysilane of formula (I) before incorporation in the rubber composition of the invention.

It should be noted that it is possible to introduce all or a portion of the covering agent in a form supported (placing on the support being carried out beforehand) on a solid compatible with the chemical structures corresponding to this compound. For example, when dividing up between the two successive phases above, it may be advantageous to introduce the second portion of the covering agent, onto the external mixer, after placing on a support in order to facilitate the incorporation thereof and the dispersion thereof.

The final composition thus obtained is subsequently calendered, for example in the form of a sheet, or else extruded, for example to form a rubber profiled element used for the manufacture of semi-finished products, such as treads, crown reinforcing plies, sidewalls, carcass reinforcing plies, beads, protectors, air chambers or airtight internal rubbers for a tubeless tyre.

The vulcanization (or curing) is carried out in a known way at a temperature generally of between 130° C. and 200° C., preferably under pressure, for a sufficient time which can vary, for example, between 5 and 90 min, depending in particular on the curing temperature, the vulcanization system adopted and the vulcanization kinetics of the composition under consideration.

The vulcanization system proper is preferably based on sulphur and on a primary vulcanization accelerator, in particular an accelerator of the sulphenamide type. Various known vulcanization activators or secondary accelerators, such as zinc oxide, stearic acid, guanidine derivatives (in particular diphenylguanidine), optional antireversion agents, and the like, incorporated during the first non-productive phase and/or during the productive phase, are additional to this crosslinking system. Sulphur is used at a preferable level of between 0.5 and 10 pce, more preferably of between 0.5 and 5.0 pce, for example between 0.5 and 3.0 pce, when the invention is applied to a tyre tread. The primary vulcanization accelerator is used at a preferable level of between 0.5 and 10 pce, more preferably of between 0.5 and 5.0 pce in particular when the invention applies to a tyre tread.

The invention relates to the rubber compositions described above both in the “raw” state (i.e., before curing) and in the “cured” or vulcanized state (i.e., after crosslinking or vulcanization). The compositions in accordance with the invention can be used alone or as a blend (i.e., as a mixture) with any other rubber composition which can be used for the manufacture of tyres.

### III. EXAMPLES OF THE IMPLEMENTATION OF THE INVENTION

### III-1. Test 1—Synthesis of the Compound Octylmethyldihydroxysilane

This example illustrates the preparation of a specific dihydroxysilane of formula (VII-1) or octylmethyldihydroxysilane:

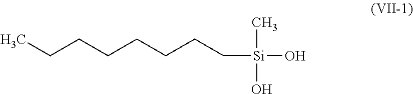

The synthesis of this compound (CAS No. 156218-16-5) was carried out by adapting the procedure described by J. A. Cella and J. C. Carpenter in “Procedures for the preparation of silanols”, Journal of Organometallic Chemistry, 480 (1994), 23-26, for the preparation of dimethyldihydroxysilane (or dimethylsilanediol).

The synthetic scheme is as follows:

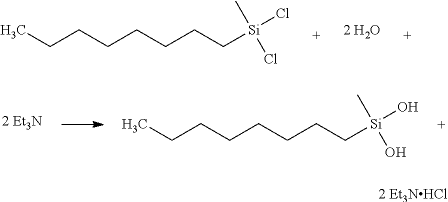

All the reactants are bought from Sigma Aldrich and are used without additional purification.

The procedure is more specifically as follows. Dichlorooctylmethylsilane (CAS No. 14799-93-0) (50.0 g, i.e. 0.22 mol), in solution in anhydrous diethyl ether (300 ml) in a dropping funnel dried beforehand in an oven, is added dropwise at 0° C., under a nitrogen atmosphere, to a 2 litre round-bottomed flask equipped with a mechanical stirrer which contains a solution of triethylamine (45.4 g, 0.45 mol, 2.04 eq), water (8.6 g, 0.48 mol, 2.2 eq), diethyl ether (700 ml) and enough acetone (approximately 70 ml) to have a homogeneous medium. The addition of the dichlorooctylmethylsilane is carried out over approximately 1 h and the resulting suspension is stirred at 0° C. for an additional 30 min. The triethylamine hydrochloride precipitate is removed by filtration and washed once with ether (approximately 100 ml). The solution is concentrated on a rotary evaporator at ambient temperature down to approximately one tenth of its initial volume. An excess of pentane (approximately 50-100 ml) is added and the evaporation is continued. The precipitate is collected by filtration and washed twice with pentane in order to remove the traces of triethylamine.

After evaporation of the residual solvents under reduced pressure, a white solid is obtained (31.7 g, 76%, melting point 58° C.). The wash liquors are again evaporated and the solid obtained is washed once with pentane. After removing the residual solvents under reduced pressure a second portion of octylmethylsilanediol is obtained (4.9 g, 12%, melting point 57° C.). The ¹H and ²⁹Si NMR analyses show that the product obtained indeed corresponds to the above formula (VII-1); according to this synthetic example, the purity obtained is greater than 99%, without an additional purification stage.

### III-2. Test 2—Preparation of the Rubber Compositions

The tests which follow are carried out in the following way: the diene elastomer (SBR and BR blend), the silica, supplemented with a small amount of carbon black, the coupling agent and then, after kneading for one to two minutes, the various other ingredients, with the exception of the vulcanization system, are introduced into an internal mixer, 70% filled and having an initial vessel temperature of approximately 90° C. Thermomechanical working (non-productive phase) is then carried out in one stage (total duration of the kneading equal to approximately 5 min) until a maximum “dropping” temperature of approximately 165° C. is reached. The mixture thus obtained is recovered and cooled and then the covering agent (when the latter is present) and the vulcanization system (sulphur and sulphenamide accelerator) are added on an external mixer (homofinisher), at 70° C., the combined mixture being mixed (productive phase) for approximately 5 to 6 min.

The compositions thus obtained are subsequently calendered, either in the form of sheets (thickness of 2 to 3 mm) or of fine sheets of rubber, for the measurement of their physical or mechanical properties, or in the form of profiled elements which can be used directly, after cutting and/or assembling to the desired dimensions, for example as tyre semi-finished products, in particular as tyre treads.

### III-3. Test 3—Characterization of the Rubber Compositions

The aim of this test is to demonstrate the improved properties of a rubber composition according to the invention in comparison with conventional rubber compositions, with or without covering agent.

For this, 5 compositions based on a diene elastomer (SBR/BR blend), reinforced with a highly dispersible silica (HDS) are prepared, these compositions differing essentially in the following technical characteristics:
composition C-1: without covering agent;
compositions C-2 and C-3: with an octyltriethoxysilane covering agent;
compositions C-4 and C-5: with an octylmethyldihydroxysilane covering agent.

The coupling agent used in each composition is TESPT, which it should be remembered has the formula (In which “Et” represents ethyl):

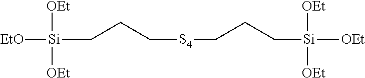

The conventional covering agent of the compositions C-2 and C-3 is a trialkoxysilane, specifically octyltriethoxysilane of formula (In which “Et” represents ethyl):

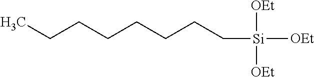

This compound, which is well known to a person skilled in the art (see, for example, patent applications mentioned in the introduction to the present account), is sold in particular by Degussa under the name “Dynasylan Octeo”.

In the compositions of the invention C-4 and C-5, the above alkoxysilane is replaced by the dihydroxysilane of formula (VII-1) prepared above:

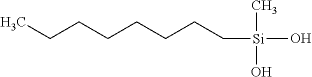

Only the compositions C-4 and C-5 are thus in accordance with the invention.

It should be noted that the two covering agents above differ essentially in the nature of their functional groups (Y) capable of reacting with the surface hydroxyl groups of the silica: alkoxyl (ethoxyl) groups for the control compositions C-2 and C-3, hydroxyl groups for the compositions C-4 and C-5 in accordance with the invention.

Furthermore, it should be emphasized here that the compositions C-4 and C-5 in accordance with the invention comprise, compared respectively with the control compositions C-2 and C-3, a level of covering agent which is equivalent, that is to say isomolar in silicon; in other words, the number of silicon atoms carrying reactive functional groups, whether hydroxyl or ethoxyl functional groups, is the same from one composition to another (C-4 compared with C-2, C-5 compared with C-3).

The formulations of the various compositions and their properties before and after curing (approximately 40 min at 150° C.) are given in Tables 1 and 2 (Table 1—levels of the various products expressed in pce or parts by weight per one hundred parts of elastomer); the vulcanization system is composed of sulphur and sulphenamide.

The examination of the various results in Table 2 shows first of all that, in comparison with the control composition C-1, the control compositions provided with a covering agent C-2 and C-3 always exhibit properties before curing which are improved:
a Mooney viscosity which is reduced, a clear indicator of an improved processability contributed by the covering agent;
faster vulcanization kinetics, illustrated by a conversion rate constant K which is greater and by a reduced curing time (T₉₉-Ti).

However, unexpectedly, the compositions of the invention C-4 and C-5, compared respectively with the control compositions C-2 and C-3, exhibit properties before curing which are again greatly improved, with in particular:
a Mooney viscosity again reduced by approximately 10%;
accelerated vulcanization kinetics (constant K), it being possible for the increase to reach more than 30%;
curing times which are again reduced, without furthermore compromising the scorch safety (i.e., without risk of premature vulcanization during the preparation of the composition in an internal mixer), as confirmed by induction periods (Ti) which are stable.

Reduced curing times are advantageous in particular for treads intended for retreading, whether “cold” retreading (use of a precured tread) or conventional “hot” retreading (use of a tread in the raw state). In the latter case, a reduced curing time, in addition to the fact that it reduces the production costs, limits the overcuring (or postcuring) imposed on the remainder of the frame (carcass) of the worn tyre (already vulcanized).

After curing, the various compositions tested differ relatively little in terms of moduli (M100 and M300) and of properties at break; at the very most there may be noted Shore hardness values which are slightly lower for the compositions of the invention C-4 and C-5, coupled with a reinforcing index (M300/M100 ratio) which is at least the same, if not even slightly improved, a clear indicator to a person skilled in the art of a very good ability of the compositions of the invention to withstand wear, at least as good as that of the reference composition C-1.

Finally and above all, the compositions of the invention C-4 and C-5 reveal, compared with the three control compositions C-1 to C-3, a hysteresis which is markedly reduced, as confirmed by tan(δ)ₘₐₓ and ΔG* values which are very substantially decreased; this is a recognized indicator of a reduction in the rolling resistance of tyres and consequently of a reduction in the energy consumption of the motor vehicles equipped with such tyres.

### III-4. Test 4

In this new rubber test, two other hydroxysilanes are compared with the octyltriethoxysilane and octylmethyldihydroxysilane tested in the preceding rubber test. These two dihydroxysilanes, dimethyldihydroxysilane and propylmethyldihydroxysilane, themselves correspond to the formula (I), except for the difference, however, that the R¹ group represents a hydrocarbon group having only 1 or 3 carbon atoms.

### III-4-1. Synthesis of dimethyldihydroxysilane and propylmethyldihydroxysilane

The synthesis of dimethyldihydroxysilane (CAS No. 1066-42-8), of formula (IX):

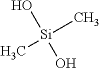

is carried out according to the same flow chart as indicated above for the dihydroxysilane of formula (VII-1), all the reactants being bought from Sigma Aldrich without additional purification.

The procedure was more specifically as follows: dichlorodimethylsilane (30 g, i.e. 0.23 mol), in solution in anhydrous diethyl ether (300 ml) is added dropwise over 45 min to a stirred solution, maintained at 0° C., of triethylamine (0.47 mol, i.e. 2.01 eq), water (0.5 mol, i.e. 2.15 eq), diethyl ether (700 ml) and acetone (70 ml). Stirring is maintained for 20 min after the end of the addition and then the triethylamine hydrochloride precipitate is filtered off. The filtrate is concentrated to one tenth by evaporation under reduced pressure at ambient temperature. An excess of pentane is then added and evaporation is continued. The white solid obtained is washed with cold pentane and then dried under reduced pressure. Dimethyldihydroxysilane or dimethylsilanediol (17.5 g) is thus obtained with a yield of 83%, the NMR analysis confirming the structure of the product obtained with a molar purity of greater than 99%.

The synthesis of propylmethyldihydroxysilane (CAS No. 18165-69-0), of formula (X):

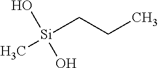

is also carried out in a similar way, as follows: dichloropropylmethylsilane (36.1 g i.e. 0.23 mol), in solution in anhydrous diethyl ether (300 ml), is added dropwise over 45 min to a stirred solution, maintained at 0° C., of triethylamine (0.47 mol, i.e. 2.01 eq), water (0.5 mol, 2.15 eq), diethyl ether (700 ml) and acetone (70 ml). Stirring is maintained for 20 min after the end of the addition and then the triethylamine hydrochloride precipitate is filtered off. The filtrate is concentrated to one tenth by evaporation under reduced pressure at ambient temperature. An excess of pentane is then added and evaporation is continued. The white solid obtained is washed with cold pentane and then dried under reduced pressure. Propylmethyldihydroxysilane or propylmethylsilanediol (18.8 g) is thus obtained with a yield of 70%, the NMR analysis confirming the structure of the product obtained with a molar purity of 93%.

### III-4-2. Rubber Tests

Two new rubber compositions, denoted C-6 and C-7, which are similar to the preceding compositions C-3 and C-5 and which differ from the latter only in the nature of the silane compound used as covering agent, are subsequently prepared:
composition C-3: with the octyltriethoxysilane covering agent;
composition C-5: with the octylmethyldihydroxysilane covering agent of formula (VII-1);
composition C-6: with the dimethyldihydroxysilane covering agent of formula (IX);
composition C-7: with the propylmethyldihydroxysilane covering agent of formula (X).

These two new compositions C-6 and C-7 are not in accordance with the invention since, in their formula, the R¹ radical (methyl or propyl) represents an alkyl having less than 4 carbon atoms.

The formulations of the various compositions and their properties before and after curing (40 min at 150° C.) are given in Tables 3 and 4. As in Test 3 above, the levels of covering agent are equivalent, that is to say isomolar in silicon; in other words, the number of silicon atoms carrying reactive functional groups, whether hydroxyl or ethoxyl functional groups, is the same from one composition to another.

On examining the various results in Table 4, it may be noted first of all that, in comparison with the control composition C-3, even if the vulcanization kinetics (constant K) are indeed improved with regard to the two new compositions tested, the Mooney viscosity is not significantly reduced, in contrast to the case of the composition in accordance with the invention composition C-5.

However, in particular and above all, it is noted that the primary technical effect obtained with the composition C-5 in accordance with the invention comprising the dihydroxysilane of formula (VII-1) in comparison with the reference composition C-3, namely a significant and unexpected reduction in the hysteresis (seen through the values of tan(δ)ₘₐₓ and ΔG*), is not reproduced with the dihydroxysilanes of formulae (IX) and (X) (compositions C-6 and C-7), the tan(δ)ₘₐₓ value remaining the same as or greater than the starting value (composition C-3).

It thus has to be concluded therefrom that this unexpected difference in results is due to the length of the R¹ hydrocarbon (alkyl) group of the formula (I), a length which is inadequate (less than 4 carbon atoms) in the case of the two silanes of formulae (IX) and (X).

### III-5. Test 5

In this new rubber test, two new hydroxysilanes are compared with the octyltriethoxysilane and octylmethyldihydroxysilane tested in the preceding rubber tests. These two hydroxysilanes, octadecylmethyldihydroxysilane and octyldimethylhydroxysilane, correspond to the formula (I) in which the R¹ group clearly represents a hydrocarbon group having at least 4 carbon atoms.

### III-5-1. Synthesis of octadecylmethyldihydroxysilane and octyldimethylhydroxysilane

The synthesis of octadecylmethyldihydroxysilane (CAS No. 7522-59-0), of formula (XI):

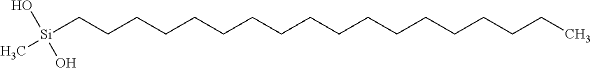

and that of octyldimethylhydroxysilane (CAS No. 64451-51-0) of formula (XII):

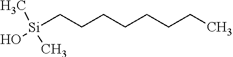

are carried out according to the same flow charts as those described above.

More specifically, octadecylmethyldichlorosilane [CAS No. 5157-75-5] (1500 g, i.e. 4.08 mol), in solution in anhydrous diethyl ether (250 ml), is added dropwise (90 min) to a mixture of water (345 g), triethylamine (1138 g) and diethyl ether (29 l) maintained at a temperature of between −2° C. and 6° C. The mixture is subsequently stirred at a temperature of between 0° C. and 5° C. for 2 h. The precipitate formed is filtered off and washed successively with 61 of demineralized water and then 3 times with 41 of demineralized water. The solid obtained is dried in the open air until a constant weight is achieved. Octadecylmethyl-dihydroxysilane or octadecylmethylsilanediol (1226 g) is thus obtained with a yield of 91% in the form of a white solid with a melting point of 87° C., the NMR analysis furthermore confirming the structure of the product obtained with a molar purity of 95%.

Furthermore, octyldimethylchlorosilane (17.3 g, i.e. 0.80 mol) is added dropwise (20 min) at −10° C. to a mixture of water (5.77 g), triethylamine (12.18 g) and diethyl ether (700 ml). The mixture is subsequently stirred for 90 min. The triethylamine hydrochloride precipitate is then filtered off and washed with 100 ml of diethyl ether. After evaporating the solvents under reduced pressure down to a volume of approximately 200 ml, the solution is washed with 2 times 100 ml of water. After separation by settling, the organic phase is dried with sodium sulphate. After evaporating the diethyl ether under reduced pressure at ambient temperature, the residue is distilled (65-67° C., 1.4 mbar). Octyldimethylhydroxysilane or octyldimethylsilanol (13.01 g) is then obtained in the form of a colourless liquid with a yield of 87%, the NMR analysis confirming the structure of the product obtained with a molar purity of 99.5%.

### III-5-2. Rubber Tests

Five new rubber compositions, denoted C-8 to C-12, based on a new diene elastomer (i.e., new SBR/BR blend), which are reinforced with a highly dispersible silica (HDS), are subsequently prepared, these compositions differing essentially in the following technical characteristics:
composition C-8: devoid of silane covering agent;
composition C-9: with the control covering agent octyltriethoxysilane;
composition C-10: with the covering agent octylmethyldihydroxysilane of formula (VII-1), already tested above;
composition C-11: with the covering agent octadecylmethyldihydroxysilane of formula (XI);
composition C-12: with the covering agent octyldimethylhydroxysilane of formula (XII).

The compositions C-10, C-11 and C-12 are all in accordance with the invention since, in their formula, the R¹ radical indeed represents an alkyl having at least 4 carbon atoms.

The formulations of these various compositions and their properties before and after curing (40 min at 150° C.) are given in Tables 5 and 6. As for the preceding tests, the levels of covering agent are equivalent, that is to say isomolar in silicon; in other words, the number of silicon atoms carrying reactive functional groups, whether hydroxyl or ethoxyl functional groups, is the same from one composition to another.

On examining the various results in Table 6, it is clearly confirmed that the compositions in accordance with the invention comprising the hydroxysilane of formula (I) exhibit an improved compromise in properties, with reduction in the Mooney viscosity (improved processability) and a conversion rate constant K which is greater (identical or faster vulcanization kinetics), and finally and above all exhibit a significant and unexpected reduction in hysteresis, seen through the tan(δ)ₘₐₓ and ΔG* values, in comparison with the two control compositions C-8 and C-9.

It is very particularly noted that the best result (composition C-11) in terms of hysteresis is obtained with the hydroxysilane compound of formula (XI), the R¹ group of which comprises 18 carbon atoms.

In conclusion, the invention here affords rubber compositions and tyres a significantly and unexpectedly improved compromise in properties, in terms of processability in the raw state, in terms of curing kinetics and especially and above all in terms of reduction in hysteresis, synonymous with a lower rolling resistance and thus with a reduced energy consumption for motor vehicles equipped with tyres in accordance with the invention.

TABLE 1

| Composition N°: | C-1 | C-2 | C-3 | C-4 | C-5 |
|---|---|---|---|---|---|
| SBR (1) | 54 | 54 | 54 | 54 | 54 |
| BR (2) | 46 | 46 | 46 | 46 | 46 |
| Silica (3) | 90 | 90 | 90 | 90 | 90 |
| Coupling agent (4) | 7.2 | 7.2 | 7.2 | 7.2 | 7.2 |
| Silane (5) | — | 1.2 | 3.8 | — | — |
| Silane (6) | — | — | — | 0.9 | 2.7 |
| Carbon black (7) | 4 | 4 | 4 | 4 | 4 |
| MES oil (8) | 5 | 5 | 5 | 5 | 5 |
| Vegetable oil (9) | 17 | 17 | 17 | 17 | 17 |
| Plasticizing resin (10) | 19 | 19 | 19 | 19 | 19 |
| DPG (11) | 2.1 | 2.1 | 2.1 | 2.1 | 2.1 |
| Antiozone wax (12) | 1.5 | 1.5 | 1.5 | 1.5 | 1.5 |
| Zinc oxide (13) | 2 | 2 | 2 | 2 | 2 |
| Antioxidant (14) | 2.2 | 2.2 | 2.2 | 2.2 | 2.2 |
| Stearic acid (15) | 3 | 3 | 3 | 3 | 3 |
| Sulphur | 1.4 | 1.4 | 1.4 | 1.4 | 1.4 |
| Accelerator (16) | 1.6 | 1.6 | 1.6 | 1.6 | 1.6 |

(1) SSBR with 25% of styrene, 59% of 1,2-polybutadiene units and 20% of trans-1,4-polybutadiene units (Tg = −24° C.); level expressed as dry SBR (SBR extended with 9% of MES oil, i.e. a total of SSBR + oil equal to 59 pce);
(2) BR (Nd) with 0.7% of 1,2-; 1.7% of trans-1,4-; 98% of cis-1,4- (Tg = −105° C.);
(3) Silica “Zeosil 1165 MP” from Rhodia, in the form of microbeads (BET and CTAB: approximately 150-160 m²/g);
(4) TESPT (“Si69” from Degussa);
(5) Octyltriethoxysilane (“Octeo” silane from Degussa);
(6) Dihydroxysilane of formula (VI) (octylmethyldihydroxysilane);
(7) N234 (Degussa);
(8) MES oil (“Catenex SNR” from Shell);
(9) Glycerol trioleate (sunflower oil comprising 85% by weight of oleic acid - “Lubrirob Tod 1880” from Novance);
(10) Polylimonene resin (“Dercolyte L120” from DRT);
(11) Diphenylguanidine (Perkacit DPG from Flexsys);
(12) Mixture of macro- and microcrystalline antiozone waxes;
(13) Zinc oxide (industrial grade - Umicore);
(14) N-(1,3-Dimethylbutyl)-N-phenyl-para-phenylenediamine (“Santoflex 6-PPD” from Flexsys);
(15) Stearin (“Pristerene 4931” - Uniqema);
(16) N-Cyclohexyl-2-benzothiazylsulphenamide (“Santocure CBS” from Flexsys).

TABLE 2

| Composition N°: | C-1 | C-2 | C-3 | C-4 | C-5 |
|---|---|---|---|---|---|
| Properties before curing: | | | | | |
| Mooney (MU) | 80 | 72 | 65 | 66 | 57 |
| Ti (min) | 5.2 | 5.3 | 5.2 | 5.5 | 5.1 |
| T₉₉ − Ti (min) | 19.2 | 16.2 | 13.8 | 14.5 | 10.5 |
| K (min⁻¹) | 0.240 | 0.284 | 0.333 | 0.317 | 0.437 |
| Properties after curing: | | | | | |
| Shore A | 65 | 63 | 64 | 62 | 61 |
| M10 (MPa) | 5.2 | 5.0 | 4.9 | 4.3 | 4.0 |
| M100 (MPa) | 1.6 | 1.5 | 1.6 | 1.5 | 1.6 |
| M300 (MPa) | 2.0 | 2.0 | 2.2 | 2.1 | 2.2 |
| M300/M100 | 1.25 | 1.32 | 1.35 | 1.36 | 1.39 |
| Elongation at break (%) | 653 | 670 | 624 | 675 | 638 |
| Breaking stress (MPa) | 19.2 | 20.4 | 19.5 | 20.8 | 19.6 |
| ΔG* (40° C.) | 3.50 | 3.10 | 3.04 | 2.36 | 2.05 |
| tanδₘₐₓ (40° C.) | 0.256 | 0.246 | 0.243 | 0.228 | 0.218 |

TABLE 3

| Composition N°: | C-3 | C-5 | C-6 | C-7 |
|---|---|---|---|---|
| SBR (1) | 54 | 54 | 54 | 54 |
| BR (2) | 46 | 46 | 46 | 46 |
| Silica (3) | 90 | 90 | 90 | 90 |
| Coupling agent (4) | 7.2 | 7.2 | 7.2 | 7.2 |
| Silane (5) | 3.8 | | | |
| Silane (6a) | | 2.7 | | |
| Silane (6b) | | | 1.8 | |
| Silane (6c) | | | | 1.3 |
| Carbon black (7) | 4 | 4 | 4 | 4 |
| MES oil (8) | 5 | 5 | 5 | 5 |
| Vegetable oil (9) | 17 | 17 | 17 | 17 |
| Plasticizing resin (10) | 19 | 19 | 19 | 19 |
| DPG (11) | 2.1 | 2.1 | 2.1 | 2.1 |
| Antiozone wax (12) | 1.5 | 1.5 | 1.5 | 1.5 |
| Zinc oxide (13) | 2 | 2 | 2 | 2 |
| Antioxidant (14) | 2.2 | 2.2 | 2.2 | 2.2 |
| Stearic acid (15) | 3 | 3 | 3 | 3 |
| Sulphur | 1.4 | 1.4 | 1.4 | 1.4 |
| Accelerator (16) | 1.6 | 1.6 | 1.6 | 1.6 |

(1) SSBR with 25% of styrene, 59% of 1,2-polybutadiene units and 20% of trans-1,4-polybutadiene units (Tg = −24° C.); level expressed as dry SBR (SBR extended with 9% of MES oil, i.e. a total of SSBR + oil equal to 59 pce);
(2) BR (Nd) with 0.7% of 1,2-; 1.7% of trans-1,4-; 98% of cis-1,4- (Tg = −105° C.);
(3) Silica “Zeosil 1165 MP” from Rhodia, in the form of microbeads (BET and CTAB: approximately 150-160 m²/g);
(4) TESPT (“Si69” from Degussa);
(5) Octyltriethoxysilane (“Octeo” silane from Degussa);
(6a) Dihydroxysilane of formula (VII-1) (octylmethyldihydroxysilane);
(6b) Dihydroxysilane of formula (X) (propylmethyldihydroxysilane);
(6c) Dihydroxysilane of formula (IX) (dimethyldihydroxysilane);
(7) N234 (Degussa);
(8) MES oil (“Catenex SNR” from Shell);
(9) Glycerol trioleate (sunflower oil comprising 85% by weight of oleic acid - “Lubrirob Tod 1880” from Novance);
(10) Polylimonene resin (“Dercolyte L120” from DRT);
(11) Diphenylguanidine (Perkacit DPG from Flexsys);
(12) Mixture of macro- and microcrystalline antiozone waxes;
(13) Zinc oxide (industrial grade - Umicore);
(14) N-(1,3-Dimethylbutyl)-N-phenyl-para-phenylenediamine (“Santoflex 6-PPD” from Flexsys);
(15) Stearin (“Pristerene 4931” - Uniqema);
(16) N-Cyclohexyl-2-benzothiazylsulphenamide (“Santocure CBS” from Flexsys).

TABLE 4

| Composition N°: | C-3 | C-5 | C-6 | C-7 |
|---|---|---|---|---|
| Properties before curing: | | | | |
| Mooney (MU) | 65 | 57 | 62 | 68 |
| Ti (min) | 5.2 | 5.1 | 5.2 | 5.0 |
| T₉₉ - Ti (min) | 13.8 | 10.5 | 9.9 | 9.9 |
| K (min⁻¹) | 0.333 | 0.437 | 0.467 | 0.465 |
| Properties after curing: | | | | |
| Shore A | 64 | 61 | 65 | 65 |
| M10 (MPa) | 4.9 | 4.0 | 4.7 | 5.0 |
| M100 (MPa) | 1.6 | 1.6 | 1.8 | 1.8 |
| M300 (MPa) | 2.2 | 2.2 | 2.5 | 2.4 |
| M300/M100 | 1.35 | 1.39 | 1.40 | 1.36 |
| Elongation at break (%) | 624 | 638 | 602 | 604 |
| Breaking stress (MPa) | 19.5 | 19.6 | 20.1 | 19.8 |
| ΔG* (40° C.) | 3.04 | 2.05 | 2.86 | 3.21 |
| tanδₘₐₓ (40° C.) | 0.243 | 0.218 | 0.243 | 0.249 |

TABLE 5

| Composition N°: | C-8 | C-9 | C-10 | C-11 | C-12 |
|---|---|---|---|---|---|
| SBR (1) | 70 | 70 | 70 | 70 | 70 |
| BR (2) | 30 | 30 | 30 | 30 | 30 |
| Silica (3) | 80 | 80 | 80 | 80 | 80 |
| Coupling agent (4) | 6.4 | 6.4 | 6.4 | 6.4 | 6.4 |
| Silane (5) | — | 2.9 | — | — | — |
| Silane (6a) | — | — | 2.0 | — | — |
| Silane (6b) | — | — | — | 3.5 | — |
| Silane (6c) | — | — | — | — | 2.0 |
| Carbon black (7) | 5 | 5 | 5 | 5 | 5 |
| MES oil (8) | 6 | 6 | 6 | 6 | 6 |
| Plasticizing resin (9) | 20 | 20 | 20 | 20 | 20 |
| DPG (10) | 1.5 | 1.5 | 1.5 | 1.5 | 1.5 |
| Antiozone wax (11) | 1.5 | 1.5 | 1.5 | 1.5 | 1.5 |
| Zinc oxide (12) | 1.5 | 1.5 | 1.5 | 1.5 | 1.5 |
| Antioxidant (13) | 2 | 2 | 2 | 2 | 2 |
| Stearic acid (14) | 2 | 2 | 2 | 2 | 2 |
| Sulphur | 1.0 | 1.0 | 1.0 | 1.0 | 1.0 |
| Accelerator (15) | 2.0 | 2.0 | 2.0 | 2.0 | 2.0 |

(1) SSBR with 25% of styrene, 59% of 1,2-polybutadiene units and 20% of trans-1,4-polybutadiene units (Tg = −24° C.); level expressed as dry SBR (SBR extended with 9% of MES oil, i.e. a total of SSBR + oil equal to 76 pce);
(2) BR (Nd) with 0.7% of 1,2-; 1.7% of trans-1,4-; 98% of cis-1,4- (Tg = −105° C.);
(3) Silica “Zeosil 1165 MP” from Rhodia, in the form of microbeads (BET and CTAB: approximately 150-160 m²/g);
(4) TESPT (“Si69” from Degussa);
(5) Octyltriethoxysilane (“Octeo” silane from Degussa);
(6a) Dihydroxysilane of formula (VII-1) (octylmethyldihydroxysilane);
(6b) Dihydroxysilane of formula (XI) (octadecylmethyldihydroxysilane);
(6c) Dihydroxysilane of formula (XII) (octyldimethylhydroxysilane);
(7) N234 (Degussa);
(8) MES oil (“Catenex SNR” from Shell);
(9) Polylimonene resin (“Dercolyte L120” from DRT);
(10) Diphenylguanidine (Perkacit DPG from Flexsys);
(11) Mixture of macro- and microcrystalline antiozone waxes;
(12) Zinc oxide (industrial grade - Umicore);
(13) N-(1,3-Dimethylbutyl)-N-phenyl-para-phenylenediamine (“Santoflex 6-PPD” from Flexsys);
(14) Stearin (“Pristerene 4931” - Uniqema);
(15) N-Cyclohexyl-2-benzothiazylsulphenamide (“Santocure CBS” from Flexsys).

TABLE 6

| Composition N°: | C-8 | C-9 | C-10 | C-11 | C-12 |
|---|---|---|---|---|---|
| Properties before curing: | | | | | |
| Mooney (MU) | 95 | 79 | 71 | 68 | 69 |
| Ti (min) | 5.9 | 7.0 | 7.3 | 7.9 | 7.5 |
| T₉₉ − Ti (min) | 33.5 | 25.0 | 23.0 | 24.9 | 20.5 |
| K (min⁻¹) | 0.138 | 0.184 | 0.201 | 0.185 | 0.224 |
| Properties after curing: | | | | | |
| Shore A | 65 | 63 | 62 | 59 | 61 |
| M10 (MPa) | 5.7 | 5.0 | 4.6 | 3.9 | 4.7 |
| M100 (MPa) | 2.2 | 2.0 | 2.0 | 1.7 | 1.8 |
| M300 (MPa) | 3.2 | 3.2 | 3.3 | 2.9 | 2.9 |
| M300/M100 | 1.46 | 1.60 | 1.64 | 1.67 | 1.56 |
| Elongation at break (%) | 533 | 537 | 539 | 575 | 596 |
| Breaking stress (MPa) | 21.4 | 22.1 | 22.0 | 21.5 | 22.9 |
| ΔG* (23° C.) | 5.28 | 4.63 | 3.18 | 2.36 | 3.52 |
| tanδₘₐₓ (23° C.) | 0.378 | 0.351 | 0.330 | 0.305 | 0.337 |

1. Rubber composition based on at least a diene elastomer, a reinforcing inorganic filler, a coupling agent and a hydroxysilane of formula (I):
R¹(R²)ₙSi(OH)₃₋ₙ
in which:
n is equal to 0, 1 or 2;
R¹ represents a hydrocarbon group having at least 4 carbon atoms;
R² represents an alkyl having from 1 to 4 carbon atoms, the R² alkyls being identical or different if n is equal to 2.

2. Composition according to claim 1, in which R¹ comprises at least 5 carbon atoms.

3. Composition according to claim 2, in which R¹ is an alkyl having from 5 to 36 carbon atoms.

4. Composition according to claim 3, in which R¹ is an alkyl having from 5 to 28 carbon atoms.

5. Composition according to claim 4, in which R¹ is an alkyl having from 5 to 20 carbon atoms.

6. Composition according to claim 1, in which R² represents a methyl or ethyl group.

7. Composition according to claim 6, in which the hydroxysilane is a hydroxysilane of formula (VI), (VII) or (VIII): 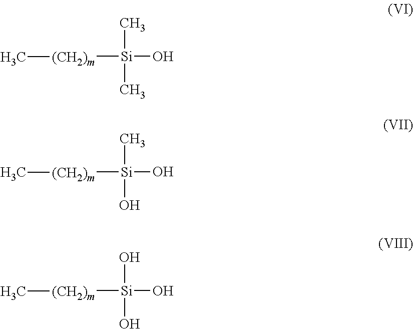
in which m is greater than 2, preferably included within a range from 3 to 35.

8. Composition according to claim 7, in which m is greater than 3, preferably included within a range from 4 to 27.

9. Composition according to claim 1, in which n is equal to 1 or 2.

10. Composition according to claim 9, in which n is equal to 1.

11. Composition according to claim 1, in which the diene elastomer is chosen from the group consisting of polybutadienes, synthetic polyisoprenes, natural rubber, butadiene copolymers, isoprene copolymers and the mixtures of these elastomers.

12. Composition according to claim 1, in which the reinforcing inorganic filler comprises a silica.

13. Composition according to claim 1, additionally comprising carbon black.

14. Tyre or tyre semi-finished product comprising a rubber composition according to claim 1.

15. Tyre tread comprising a composition according to claim 1.

16. Use of a rubber composition according to claim 1 for the manufacture of a tyre or of a tyre semi-finished product.

17. Process for preparing a rubber composition according to claim 1, the said process comprising the following stages:
incorporating in a diene elastomer, during a first “non-productive” stage, at least one reinforcing inorganic filler and one coupling agent, the combined mixture being kneaded thermomechanically until a maximum temperature of between 110° C. and 190° C. is reached;
cooling the combination to a temperature of less than 100° C.;
subsequently incorporating, during a second “productive” stage, a crosslinking (or vulcanizing) system;
kneading the combined mixture until a maximum temperature of less than 120° C. is reached,
and wherein a hydroxysilane of formula (I):
R¹(R²)ₙSi(OH)₃₋ₙ
in which:
n is equal to 0, 1 or 2;
R¹ represents a hydrocarbon group having at least 4 carbon atoms;
R² represents an alkyl having from 1 to 4 carbon atoms, the R² alkyls being identical or different if n is equal to 2,
is additionally incorporated during the non-productive stage and/or the productive stage.
